(19) United States
(12) Patent Application Publication
(10) Pub. No.: US 2016/0062544 A1
(43) Pub. Date: Mar. 3, 2016

(54) INFORMATION PROCESSING APPARATUS, AND DISPLAY CONTROL METHOD

(71) Applicant: Kabushiki Kaisha Toshiba, Tokyo (JP)

(72) Inventors: Kyohei MATSUDA, Ome Tokyo (JP); Yoshihiro KANEKO, Fussa Tokyo (JP)

(21) Appl. No.: 14/938,678

(22) Filed: Nov. 11, 2015

Related U.S. Application Data
(63) Continuation of application No. PCT/JP2013/068558, filed on Jul. 5, 2013.

(51) Int. Cl. G06F 3/041; G06T 3/40; G06F 3/038

(52) U.S. Cl. CPC G06F 3/0416; G06F 3/038; G06F 3/0412; G06T 3/40; G06F 2203/04106

(57) ABSTRACT

According to one embodiment, an information processing apparatus comprises a display, a touch panel, a detector, and a processor. The display comprises a display screen. The touch panel is provided on the display screen and configured to detect a touch operation. The detector is configured to detect whether an input operation by an input device is available, the input device being different from the touch panel. The processor is configured to set, when the input operation by the input device is available, a first resolution on the display screen, and when the input operation by the input device is not available, a second resolution on the display screen, the second resolution different from the first resolution.

### CROSS-REFERENCE TO RELATED APPLICATIONS

This application is a continuation of International application Ser. No. PCT/JP2013/068558, filed on Jul. 5, 2013, the entire contents of which are incorporated herein by reference.

### FIELD

Embodiments described herein relate generally to an information processing apparatus, and a display control method.

### BACKGROUND

When a mobile terminal (an example of an information processing apparatus), such as a tablet personal computer (PC) or a smartphone, is operated by a touch operation, operability is improved as a display size of an operation target image (for example, a window, an application button, or the like) of the touch operation is increased. However, with an increase in the size of the operation target image, information obtained from a display screen of the mobile terminal is reduced. In contrast, when the mobile terminal is operated by a mouse or a keyboard, a more detailed operation than the touch operation is available. Therefore, it is not necessary to increase the display size of the operation target image, and information obtained from the display screen is increased as the display size of the operation target image is reduced. In this manner, in the mobile terminal, the operability of the operation target image and the information obtained from the display screen vary depending on the display size of the operation target image.

Incidentally, in a conventional technology, to enable both an operation by a touch operation and an operation by a mouse or a keyboard, an operating system (OS) of a mobile terminal has a function to switch between a touch user interface (UI) for the operation by the touch operation and a desktop UI for the operation by the mouse or the keyboard in accordance with an operation by a user. However, an operation target image is so large that it is difficult to operate the touch UI by the mouse or the keyboard, and an operation target image is so small that it is difficult to operate the desktop UI by the touch operation; therefore, it is necessary for a user to manually switch between the touch UI and the desktop UI depending on an operation method.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1A and FIG. 1B are an exemplary diagram for explaining an outline and a use mode of an information processing apparatus according to an embodiment;

FIG. 2 is an exemplary block diagram illustrating an example of a hardware configuration of the information processing apparatus according to the embodiment;

FIG. 3 is an exemplary block diagram illustrating a functional configuration of the information processing apparatus according to the embodiment; and

FIG. 4 is an exemplary flowchart illustrating the flow of a process of switching a resolution of a display screen of the information processing apparatus according to the embodiment.

### DETAILED DESCRIPTION

In general, according to one embodiment, an information processing apparatus comprises a display, a touch panel, a detector, and a processor. The display comprises a display screen. The touch panel is provided on the display screen and configured to detect a touch operation. The detector is configured to detect whether an input operation by an input device is available, the input device being different from the touch panel. The processor is configured to set, when the input operation by the input device is available, a first resolution on the display screen, and when the input operation by the input device is not available, a second resolution on the display screen, the second resolution different from the first resolution.

An embodiment of an information processing apparatus, and a display control method will be described below with reference to the accompanying drawings.

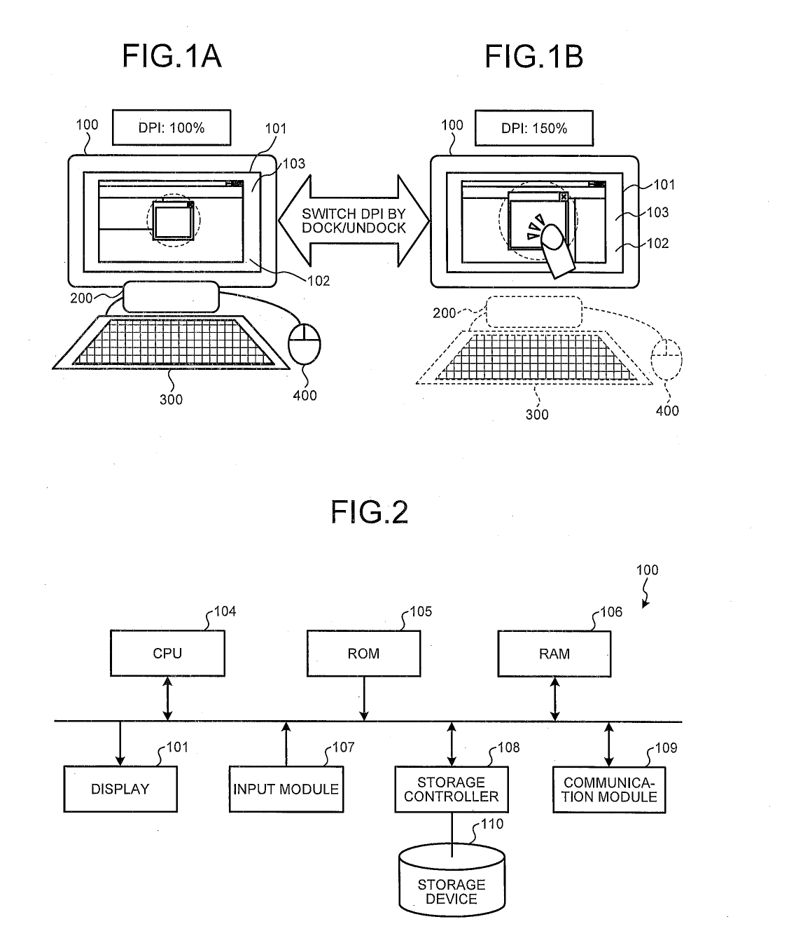

FIG. 1A and FIG. 1B are a diagram for explaining an outline and a use mode of an information processing apparatus according to an embodiment. An information processing apparatus 100 according to the embodiment may be a smartphone, a personal computer (PC), a tablet terminal, a mobile phone, or the like. In the embodiment, as illustrated in FIG. 1A and FIG. 1B, the information processing apparatus 100 comprises a display 101 comprising a display screen 102, and a touch panel 103 that is provided on the display screen 102 and configured to detect a touch operation. Further, as illustrated in FIG. 1A and FIG. 1B, the information processing apparatus 100 is attachable and detachable to and from a dock 200 connected to operation modules, such as a keyboard 300 and a mouse 400 (examples of a pointing device). As illustrated in FIG. 1A and FIG. 1B, the information processing apparatus 100 switches a resolution (dots per inch (DPI)) of the display screen 102 depending on whether it is attached to (docked with) the dock 200 or detached from (undocked from) the dock 200.

FIG. 2 is a block diagram illustrating an example of a hardware configuration of the information processing apparatus according to the embodiment. As illustrated in FIG. 2, the information processing apparatus 100 comprises a central processing unit (CPU) 104, a read only memory (ROM) 105, a random access memory (RAM) 106, the display 101, an input module 107, a storage controller 108, a communication module 109, and a storage device 110.

The CPU 104 executes various processes in cooperation with various control programs stored in the ROM 105 or the like by using the RAM 106 as a work area, and integrally controls operations of respective modules in the information processing apparatus 100.

The ROM 105 stores therein programs related to the control of the information processing apparatus 100, various kinds of setting information, and the like in a non-rewritable manner. The RAM 106 is a volatile storage medium and functions as a work area for the CPU 104.

The display 101 comprises the display screen 102 configured with a liquid crystal display (LCD), an organic electroluminescence (EL), or the like, and displays progress and results of processes, or the like under the control of the CPU 104.

The input module 107 comprises an input device, such as the touch panel 103 configured to detect a touch operation on the display screen 102 or a button (not illustrated), and notifies the CPU 104 of a command or information that is input by a user through the input device.

The storage controller 108 controls operations of the storage device 110, and performs a process on the storage device 110 in response to a request, such as data write or data read, input from the CPU 104. Herein, the storage device 110 is a storage device comprising a recording medium, such as a magnetic disk, a semiconductor memory, or an optical disk.

The communication module 109 is a wireless communication interface configured to establish communication with an external apparatus (not illustrated) and perform transmission and reception of data.

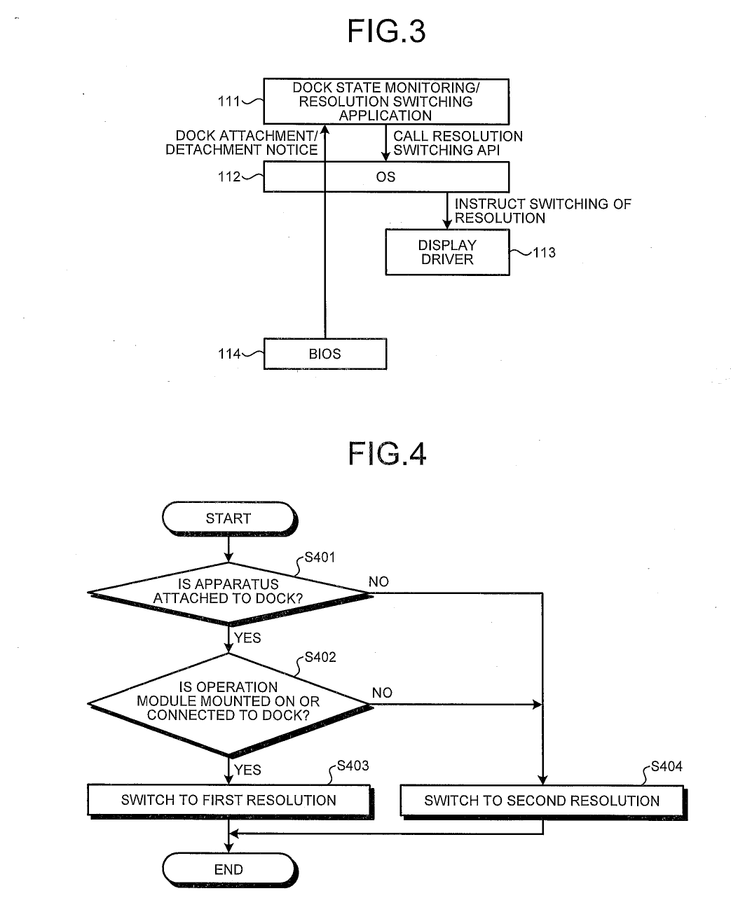

FIG. 3 is a block diagram illustrating a functional configuration of the information processing apparatus according to the embodiment. The information processing apparatus 100 comprises a basic input/output system (BIOS) 114, a dock state monitoring/resolution switching application 111, an operating system (OS) 112, and a display driver 113.

The BIOS 114 outputs, to the dock state monitoring/resolution switching application 111, a dock attachment/detachment notice that indicates attachment of the information processing apparatus 100 to the dock 200, detachment of the information processing apparatus 100 from the dock 200, whether an operation module (for example, the keyboard 300, the mouse 400, or the like) is mounted on the dock 200 to which the information processing apparatus 100 is attached, or whether the operation module is connected to the dock 200 to which the information processing apparatus 100 is attached.

The dock state monitoring/resolution switching application 111 continuously operates on the OS 112, and calls a resolution switching application program interface (API), which is for switching a resolution of the display screen 102, of the OS 112 in accordance with the dock attachment/detachment notice.

The OS 112 instructs the display driver 113 to switch the resolution of the display screen 102 in accordance with the call of the resolution switching API. The display driver 113 switches the resolution of the display screen 102 in accordance with the instruction for switching the resolution of the display screen 102. In the embodiment, the dock state monitoring/resolution switching application 111, the OS 112, and the display driver 113 function as a display controller.

Next, a process of switching the resolution of the display screen 102 by the information processing apparatus 100 according to the embodiment will be described with reference to FIG. 1A to 4. FIG. 4 is a flowchart illustrating the flow of a process of switching the resolution of the display screen of the information processing apparatus according to the embodiment.

The dock state monitoring/resolution switching application 111, upon receiving a dock attachment/detachment notice from the BIOS 114, determines whether the information processing apparatus 100 is attached to (docked with) the dock 200 based on the dock attachment/detachment notice (S401). When determining that the information processing apparatus 100 is attached to the dock 200 (Yes at S401), the dock state monitoring/resolution switching application 111 determines whether an operation module (for example, the keyboard 300, the mouse 400, or the like) is mounted on the dock 200 to which the information processing apparatus 100 is attached or whether the operation module is connected to the dock 200 based on the dock attachment/detachment notice (S402).

When the information processing apparatus 100 is attached to the dock 200 (Yes at S401), and when the operation module is mounted on the dock 200 to which the information processing apparatus 100 is attached or when the operation module is connected to the dock 200 (Yes at S402), the dock state monitoring/resolution switching application 111 (an example of a detector) detects that an operation input by a predetermined operation module different from the touch panel 103 is available, and calls the resolution switching API of the OS 112.

In the embodiment, the dock state monitoring/resolution switching application 111 detects that the operation input by the predetermined operation module different from the touch panel 103 is available when the information processing apparatus 100 is attached to the dock 200 and when the operation module is mounted on the dock 200 or the operation module is connected to the dock 200; however, it is not limited thereto.

For example, the dock state monitoring/resolution switching application 111 may detect that the operation input by the predetermined operation module different from the touch panel 103 is available when the information processing apparatus 100 is attached to a cradle and when the operation module is mounted on the cradle or the operation module is connected to the cradle.

Further, when the information processing apparatus 100 is configured to be able to switch between a first use mode, which is suitable for a touch operation using the touch panel 103, and a second use mode, which is operable by an operation module (for example, a keyboard, a touch pad, or the like), by sliding the display screen 102 on the keyboard, and if the information processing apparatus 100 is switched to the second use mode, the dock state monitoring/resolution switching application 111 may detect that the operation input by the predetermined operation module different from the touch panel 103 is available.

Furthermore, the dock state monitoring/resolution switching application 111 may detect that the operation input by the predetermined operation module different from the touch panel 103 is available when the operation module is connected to the information processing apparatus 100 wirelessly or in a wired manner.

The OS 112, when it is detected that the operation input by the predetermined operation module different from the touch panel 103 is available and when the resolution switching API is called, instructs the display driver 113 to switch the resolution of the display screen 102 to a first resolution that is set for the operation module. Herein, the first resolution is a resolution higher than a second resolution that is set for the touch panel 103. In the embodiment, when it is detected that the operation input by the predetermined operation module different from the touch panel 103 is available, as illustrated in FIG. 1A, the OS 112 notifies the display driver 113 of a value (for example, 100%) indicating the first resolution, thereby instructing switching of the resolution of the display screen 102 to the first resolution.

In the embodiment, when a resolution is input through the input module 107, the OS 112 sets the first resolution and the second resolution in accordance with the input resolution. Specifically, if a resolution is input through the input module 107 while it is detected that the operation input by the predetermined operation module different from the touch panel 103 is available, the OS 112 sets the input resolution as the first resolution and sets a resolution lower than the input resolution (the first resolution) as the second resolution. In contrast, if a resolution is input through the input module 107 while it is not detected that the operation input by the predetermined operation module different from the touch panel 103 is available, the OS 112 sets the input resolution as the second resolution and sets a resolution higher than the input resolution (the second resolution) as the first resolution.

The display driver 113, when it is instructed to switch to the first resolution by the OS 112, switches the resolution of the display screen 102 to the first resolution (S403). Therefore, when it is detected that the operation input by the predetermined operation module different from the touch panel 103 is available, as illustrated in FIG. 1A, the resolution of the display screen 102 is increased, and a display size of an operation target image (for example, an icon or the like), which is for the touch operation by the touch panel 103 or for the operation input by the predetermined operation module different from the touch panel 103 in an image displayed on the display screen 102, can be set to a display size suitable for the operation input by the operation module (in other words, a display size smaller than a display size suitable for the touch operation by the touch panel 103). Consequently, it is possible to prevent the display size from becoming too large for the operation input by the operation module, and it is possible to increase information obtained from the display screen 102. Herein, the display size is a size of an image (an operation target image in this example) actually displayed on the display screen 102 (that is, a visual size of the operation target image).

In contrast, when it is determined that the information processing apparatus 100 is detached (undocked) from the dock 200 (No at S401), or when the operation module is not mounted on the dock 200 to which the information processing apparatus 100 is attached and when the operation module is not connected to the dock 200 (No at S402), the dock state monitoring/resolution switching application 111 detects that the operation input by the predetermined operation module different from the touch panel 103 is not available, and calls the resolution switching API of the OS 112.

The OS 112, when it is detected that the operation input by the predetermined operation module different from the touch panel 103 is not available and when the resolution switching API is called (that is, when it is not detected that the operation input by the predetermined operation module different from the touch panel 103 is available), instructs the display driver 113 to switch the resolution of the display screen 102 to the second resolution, which is different from the first resolution and which is set for the touch panel. In the embodiment, when it is not detected that the operation input by the predetermined operation module different from the touch panel 103 is available, as illustrated in FIG. 1B, the OS 112 notifies the display driver 113 of a value (for example, 150%) indicating the second resolution, thereby instructing switching of the resolution of the display screen 102 to the second resolution.

The display driver 113, when it is instructed to switch to the second resolution, switches the resolution of the display screen 102 to the second resolution, which is different from the first resolution and which is set for the touch panel 103 (S404). Therefore, when it is not detected that the operation input by the predetermined operation module different from the touch panel 103 is available, as illustrated in FIG. 1B, the resolution of the display screen 102 is reduced, and a display size of an operation target image (for example, an icon or the like), which is for the touch operation by the touch panel 103 or for the operation input by the operation module in an image displayed on the display screen 102, can be set to a display size suitable for the touch operation by the touch panel 103 (in other words, a display size greater than a display size suitable for the operation input by the operation module). Consequently, it is possible to prevent the display size from becoming too small for the touch operation by the touch panel 103.

In this manner, according to the information processing apparatus 100 of the embodiment, it is not necessary for a user to manually switch the resolution of the display screen 102 depending on whether to operate the information processing apparatus 100 by the touch panel 103 or by the predetermined operation module different from the touch panel 103. Therefore, it is possible to enhance the convenience of the information processing apparatus 100.

Further, the display driver 113 displays the operation target image (for example, an icon or the like), which is for the touch operation by the touch panel 103 or for the operation input by the predetermined operation module different from the touch panel 103 in an image displayed on the display screen 102, in a predetermined display size. Therefore, even by switching to the first resolution or the second resolution, it is possible to display the operation target image in the same size. Consequently, it is possible to prevent the operation target image from being displayed in a too small display size when the resolution of the display screen 102 is switched to the first resolution.

Furthermore, the display driver 113 displays an image displayed on the display screen 102 in a predetermined display size (an image display size). Therefore, even by switching to the first resolution or the second resolution, it is possible to display the image in the same size. Consequently, it is possible to prevent the display size of the image displayed on the display screen 102 from becoming so small that displayed contents may not be viewed when the resolution of the display screen 102 is switched to the first resolution.

Moreover, the display driver 113 may set the first resolution and the second resolution in accordance with an application related to display of information on the display screen 102. For example, if information displayed on the display screen 102 by an application is text data, it is considered that visibility is improved when a display size of text displayed on the display screen 102 is reduced; therefore, the display driver 113 increases the preset first resolution and the preset second resolution by predetermined values.

In the embodiment, when the operation input by the predetermined operation module different from the touch panel 103 is not available, the OS 112 and the display driver 113 (a display controller) switch to the second resolution that is lower than the first resolution set for the touch panel 103; however, it is not limited thereto as long as the resolution of the display screen 102 is changed between when the operation input by the predetermined operation module different from the touch panel 103 is available and when the operation input by the predetermined operation module different from the touch panel 103 is not available. For example, when the operation input by the predetermined operation module different from the touch panel 103 is not available, the OS 112 and the display driver 113 (the display controller) may switch to the second resolution that is higher than the first resolution set for the touch panel 103. Accordingly, when the operation input is performed on the touch panel 103 by using a device, such as a stylus pen, capable of performing a detailed touch operation, it becomes possible to prevent an operation target image from being displayed in a too large display size, and improve operability of the operation target image.

A program executed by the information processing apparatus 100 of the embodiment is provided by being recorded in a computer-readable recording medium, such as a compact disc read only memory (CD-ROM), a flexible disk (FD), a compact disc recordable (CD-R), or a digital versatile disk (DVD), in an installable or an executable file format.

Further, the program executed by the information processing apparatus 100 of the embodiment may be stored in a computer connected to a network, such as the Internet, and may be provided by being downloaded via the network. Furthermore, the program executed by the information processing apparatus 100 of the embodiment may be provided or distributed via a network, such as the Internet.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

what is claimed is:

1. An information processing apparatus comprising:
a display comprising a display screen;
a touch panel on the display screen and configured to detect a touch operation;
a detector configured to detect whether an input operation by an input device is available, the input device being different from the touch panel; and
a processor configured to set, when the input operation by the input device is available, a first resolution on the display screen, and when the input operation by the input device is not available, a second resolution on the display screen, the second resolution different from the first resolution.

2. The information processing apparatus of claim 1, wherein
when the input operation by the input device is available, the processor is configured to set the first resolution on the display screen, the first resolution set by the input device, and
when the input operation by the input device is not available, the processor is configured to set the second resolution on the display screen, wherein the second resolution is for touch panel operation and different from the first resolution.

3. The information processing apparatus of claim 1, wherein the first resolution is higher than the second resolution.

4. The information processing apparatus of claim 1, wherein the detector further configured to detect that the input operation by the input device is available when the information processing apparatus is attached to a dock and the input device is mounted on the dock or connected to the dock.

5. The information processing apparatus of claim 2, wherein the processor further configured to receive a resolution input for the display screen and set the first resolution or the second resolution based on the input resolution.

6. The information processing apparatus of claim 1, wherein the processor configured to display an operation target image in a first display size on the display screen for the touch operation by the touch panel and for the input operation by the input device.

7. The information processing apparatus of claim 1, wherein the processor is further configured to display an image on the display screen in a second image display size on the display screen for the touch operation by the touch panel and for the input operation by the input device.

8. The information processing apparatus of claim 1, wherein the processor is configured to set the first resolution or the second resolution based on an application related to display of information on the display screen.

9. The information processing apparatus of claim 1, wherein the input device is a pointing device.

10. A display control method performed by an information processing apparatus comprising:
a display comprising a display screen; and
a touch panel on the display screen and configured to detect a touch operation, the display control method comprising:
detecting whether an input operation by a designated input device is available, the input device different from the touch panel; and
setting, when the input operation by the input device is available, a first resolution on the display screen, when the input operation by the operation module is not available, a second resolution on the display screen, the second resolution different from the first resolution.
